(19) United States
(12) Patent Application Publication
(10) Pub. No.: US 2023/0128427 A1
(43) Pub. Date: Apr. 27, 2023

(54) N-SUM NUMBERS IN CRAPS GAME

(71) Applicant: Ryan Renyong Cui, Las Vegas, NV (US)

(72) Inventor: Ryan Renyong Cui, Las Vegas, NV (US)

(21) Appl. No.: 17/509,139

(22) Filed: Oct. 25, 2021

(51) Int. Cl. G07F 17/32; A63F 3/00

(52) U.S. Cl. CPC G07F 17/323; A63F 3/00157; G07F 17/322; G07F 17/3258; G07F 17/3288

(57) ABSTRACT

A gaming table system and a method of executing a side bet on a craps gaming table by:
providing a craps gaming table with indicia illustrating fourteen possible dice roll outcomes. At least one player position placing value at risk in the form of a physical chip or electronic data entry on a side bet wager;
the side bet wager based on at least three different ones of the fourteen possible dice roll outcomes occurring before a seven outcome is rolled, with payout odds on the side bet dependent upon at least one of the following side bet conditions providing payout odds in identified ascending order of odds. Upon each outcome of any one of the fourteen possible dice roll outcomes, a no-value lammer is placed over each the dice roll outcomes. A house resolving the side bet when a side bet conditions is met.

### BACKGROUND OF THE INVENTION

### 1. Field of the Invention

The present invention relates to the field of gaming, particularly table gaming and more particularly table gaming using dice in an underlying game such as craps or Sic Bo.

### 2. Background of the Art

Dice games are one of the oldest forms of gaming entertainment, and recently they have made a resurgence in casino table gaming environments. There are basically two major gaming events using dice, craps and Sic Bo.

Craps is one of the oldest forms of wagering, and is based upon rigid probabilities for the occurrence of specific combinations of dice faces being exposed after a roll. There are 36 possible combinations of dice faces that may appear in the roll of two dice with six faces identified with values of 1, 2, 3, 4, 5, and 6. The combinations of values or count (and number of combinations that provide those values) are 2(1), 3(2), 4(3), 5(4), 6(5), 7(6), 8(5), 9(4), 10(3), 11(2) and 12(1). This statistical breakdown shows there are thirty-six (36) combinations of dice, and the probabilities of events assists in determining the odds provided by the house on each throw of the dice and the overall odds and house hold percentage on every wager made at the craps table. The available wagers have been known for many years, and few additional wagers or additional table displays have been added to standard craps games over the years. One of the few newer additions to craps table displays (printing on the surface of the felt table top) has been the provision of specific boxes for placement of hopping bets at the table. The boxes consist of a box for every dice combination (except 1-1, 1-2, 6-5 and 6-6, which are, in effect, hopping bets and have available betting boxes on the table) where wagers can be placed on that specific event. The nature of wagering at the craps table will be described in greater detail in the Detailed Description of the Invention.

If the player throws a preselected winning combination, such as a 4-5-6, triple, or pair and a 6, the shooter wins. If the shooter throws a preselected losing combination, such as a 1-2-3 or a pair and a one, the shooter loses. If the shooter throws a third combination, such as a pair and a 2-3-4 or 5, then the player throws in an attempt to beat the shooter. If the player throws a preselected combination, such as a 4-5-6, or a pair and single die having a value higher than that of the shooter, the player wins. If the player throws a preselected loser, such as a 1-2-3, or a pair and single die having a value less than that of the shooter, the player loses. If the player or shooter does not throw one of above stated winning or losing combinations, then the shooter or player must throw again. Each player may place a second bet that the outcome of the game will result in predetermined winning die combination yielding a predetermined winning payout. A player may also place bonus bet means, wherein if that particular throw results in a preselected combination, such as triple sixes, the player is entitled to a throw. If the player throws another preselected combination, such as a triple six, the player is entitled to a large winning payout.

U.S. Pat. No. 5,487,547 describes a wagering method and betting table for craps with a progressive bet or jackpot bet provided for a specific number and type of consecutive doubles being rolled. Specifically, the progressive wager is for doubles 2, 4, 6, 8, 10 and 12 being rolled in any order with no other rolls being present.

U.S. Pat. No. 5,490,670 describes a layout and method of play of the game of craps wherein a pair of dice is used, the dice being of a size for manually rolling to present one of eleven different numbers which define a plurality of point numbers, at least one natural number, and at least one craps number. A gaming layout provides a flat surface upon which said dice may be rolled and upon which bets may be laid by physical placement of wagers, said flat surface including indicia thereon representing a plurality of wager areas, said wager areas including: (a) a pass line area for receiving a wager betting both (i) that one or more rolls of dice will yield an established first point number without rolling the number “7”; and (ii) that a natural number is rolled prior to establishing the first point number or prior to rolling a craps number; (b) a don’t pass area for receiving a wager betting both (i) that one or more rolls of the dice will yield the number “7” prior to the rolling of an established first point number; and (ii) that a craps number is rolled prior to establishing the first point number or prior to rolling a natural number; and (c) a jackpot area for receiving a wager that a set of a plurality of dice outcomes are rolled, said set having a remote probability of occurrence, and said set being randomly generated at a certain point in the play.

U.S. Pat. No. 5,728,002 describes a craps game is disclosed that incorporates a jackpot wagering area in a traditional craps game. In the jackpot wagering area, a player may make a bet that covers multiple wagers, including at least one jackpot sequence wager that a jackpot sequence of dice outcomes will be rolled. The jackpot sequence has a relatively remote possibility of occurrence and, correspondingly, a high payoff. A jackpot wagering area bet covers wagers in addition to the jackpot sequence wager. For example, the bet may also cover an additional jackpot sequence wager, a lower payoff sequence wager, or a traditional craps wager.

U.S. Pat. No. 5,829,749 describes a method of playing a craps game is disclosed that incorporates a jackpot wagering area in a traditional craps game. The method includes receiving a bet that a jackpot sequence of dice outcomes will be rolled. The jackpot sequence has a relatively remote possibility of occurrence and, correspondingly, a high payoff. A jackpot wagering area bet may cover wagers in addition to the jackpot sequence wager. For example, the bet may also cover an additional jackpot sequence wager, a lower payoff sequence wager, or a traditional craps wager. Also, the method of playing a craps game with a jackpot sequence wager may be played on a video screen.

U.S. Pat. No. 6,655,689 describes a proposition bet for Craps referred to as a FIRE BET™ The method includes predetermining a schedule of a pay-out table, players placing FIRE BET™ wagers at respective player betting areas prior to a shooter’s initial come out; accumulating points responsive to outcomes of the shooter’s dice throws, wherein points are made when a number 4, 5, 6, 8, 9 or 10 is twice rolled before sevening out, and wherein repeating of any made number is ignored, and making a pay-out based upon the points accumulated and the schedule.

U.S. Pat. No. 8,540,240 (Golden) evidences a casino craps table layout is provided with unique wagering opportunities. There are specific wagering areas for placing a wager on at least one of two new wagering opportunities. These new wagering opportunities are selected from the group consisting of a) a wager that the next roll of the dice will be a hard 4, 6, 8 or 10 and b) a wager that the next roll of the dice will be a pair of numbers. Another new wagering opportunity is a placed wager for any specific number (e.g., 4, 5, 6, 8, 9, and 10).

Sic Bo, meaning “dice pair” is an ancient Chinese gambling game. It is very popular in Macau, in my estimation second to baccarat only. In the United States is often found in the Asian gaming rooms, especially in Atlantic City. The large Las Vegas properties will usually have one table in the general casino.

Another game is based on a shooter hitting combinations of total numbers before any seven is rolled (on a continuing roll or on a come-out roll). The combinations of numbers are any 2, 3, 4, 5, and 6 (All Small at 30:1 odds), any 8, 9, 10, 11 and 12 (All Tall at 30:1 odds) or all of those numbers (Hit Them All at 125:1 odds). This game requires a different printing of the felt layout and the use of lammers or plastic markers that overlay each of the numbers under the All Small and All Tall series of numbers to identify when each total number is made.

The game uses three dice and a table with a variety of betting options on the roll of those dice. The odds and table layout may also vary from place to place. However, the payoffs are the same across Atlantic City and Macau, but different from each other. In Vegas and on the Internet casinos, anything is possible.

Following is a list of the bets available. The payoffs vary on some bets, from casino to casino, so for those bets a range of viable payoffs is indicated.

Small: Wins on total of 4-10, except for a three of a kind. Probability of winning is 48.61%. Pays 1 to 1. House edge is 2.78%.

Big: Wins on total of 11-17, except for a three of a kind. Probability of winning is 48.61%. Pays 1 to 1. House edge is 2.78%. Total of 4 and 17: Pays 50 to 1 in Macau, 60 to 1 in Atlantic City, and 62 to 1 in Australia.

Total of 5 and total of 16: Pays 18 to 1 in Macau, 30 to 1 in Atlantic City, and 31 to 1 in Australia.

The Pass bet is put on the pass line itself on a come-out roll. You can tell it is a come-out roll, if there is a black laminated marker on the table that says “off”. Players will win on come out roll is a 7 or 11, and lose on come our toll is a 2,3 or 12. If any other total is rolled (4,5.6,7,8,9 or 10) that total is called “the Point.” The dealer will turn over the marker that says “off” to the white “on” side. And place it on an area of the table with that number.

Once a point has been established, the shooter will continue to throw the dice until throws the point number again or throws a 7. If a 7 comes before the point, then you lose. If the point is rolled first, then you win.

In craps, the players may bet on 4,5,6,8,9 and 10 after the point has been established, it is called “Place bet” and if it is rolled before the 7, the bet wins. But once it is rolled 7, when the point is established, all the place bet loses, Called “7 out”

However, the shooter can “7 out.” The shooter then forfeits his or her turn and passed the right to dice throwing to the next shooter. This next shooter will then throw an initial come out after bets have been placed, as described hereinabove.

Many craps tables have printed positions on them for “hopping” wagers. These wagers are labeled for specific combinations of numbers, including 2-2, 3-1, 4-1, 3-2, 3-3, 5-1, 4-2, 6-2, 5-3, 4-4, 6-3, 5-4, 5-5, and 6-4. These are located in a specific proposition bet (single roll outcomes) on the craps table. Note that positions for 1-1, 1-2, 6-5, 6-6 and any seven combination are on separate locations on the gaming table.

While the game of craps played according to the standard rules is exciting and enjoyable to play, what remains needed in the art is an improvement in the form of a simply executed proposition wager which provides the bettor the possibility of a high pay out relative to the value of the bet. It would be desirable to add additional wagers and especially additional proposition wagers to the play at a dice table to add interest and excitement to the game, to increase potential winnings or house hold, and to advance the game of craps.

### SUMMARY OF THE INVENTION

The present invention is an improvement to the standard rules of craps in the form of a simply executed side bet which provides the better possibility of high pay out with progressive event, referred to hereinafter as a “COMPLETE CRAPS™.”

A gaming table system and a method of executing a side bet on a craps gaming table by:
providing a craps gaming table with indicia illustrating fourteen possible dice roll outcomes (excluding 1-1, 1-2, 5-6 and 6-6 as part of the wager). At least one player position placing value at risk in the form of a physical chip or electronic data entry on a side bet wager;
the side bet wager based on at least three different ones of the fourteen possible dice roll outcomes occurring before a seven outcome is rolled, with payout odds on the side bet dependent upon at least one of the following side bet conditions providing payout odds in identified ascending order of odds. Upon each outcome of any one of the fourteen possible dice roll outcomes, a no-value lammer is placed over each the dice roll outcomes. A house resolving the side bet when a side bet conditions is met. A special wagering area for this side bet is preferably added to a standard table as a detachable wager holder.

### BRIEF DESCRIPTION OF THE FIGURES

FIG. 1 shows a table layout 10 with Hopping Bets or Complete Craps Indicators, with area 12 being relatively standard on craps tables, as separate areas are provided for specific wagers on 1-1, 1-2, 5-6 and 6-6.

FIG. 2A shows Position Indicators for placement of Complete Craps Wager for individual player positions, 1-8 on one side of a craps table and 11-88 on another side of the craps table.

FIG. 2B is a screen shot or display panel at a gaming table a different orientation of information on the display screen, but still providing the information as in FIG. 1.

FIG. 3 shows an electronic display of past occurrences (the numbers being crossed out).

FIG. 4A shows a side view of a side bet holder attached to a table surface.

FIG. 4B shows a top view of a lammer for the side bet which contains a Player ID (here RFID chip) slid into a side bet restrainer.

FIG. 4C shows a side view of a multiple lammer restrainer that may be applied to a craps table top, allowing multiple players to make an identical side bet wager with each different player lammer being viewable.

### DETAILED DESCRIPTION OF THE INVENTION

The present invention is an improvement to the standard rules of craps in the form of a simply executed side bet which provides the better possibility of high pay out with progressive event, referred to hereinafter as a “COMPLETE CRAPS™.”

A COMPLETE CRAPS™ wager has 4 levels of pay outs, depends on shooter is able to complete many combinations of numbers (4,5,6,8,9 and 10.)

Here is all the combination that shooter will looking for:

| | | | | | |
|---|---|---|---|---|---|
| 4 | 5 | 6 | 8 | 9 | 10 |
| 1-3 | 1-4 | 1-5 | 2-6 | 3-6 | 4-6 |
| 2-2 | 2-3 | 2-4 | 3-5 | 4-5 | 5-5 |
| | | 3-3 | 4-4 | | |

(There are 14 possible Combinations)

Here are numerous (especially 4) levels of jackpot pay outs before any seven out and/or before any seven-out or a come-out seven roll:

| | |
|---|---|
| Complete 6 numbers | 100% of progressive |
| Complete 5 numbers | 10% of progressive |
| Complete 4 numbers | at least 2:1 to 1 |
| Complete 3 numbers | at least 5:6 to 1 |

This invention is the first jack pot bet with progressive event in game of “CRAPS.” Also bring new adventure for craps player.

The gaming event and system many be further described as a method of executing a side bet on a craps gaming table comprising:

providing a craps gaming table with indicia illustrating fourteen possible dice roll outcomes of exactly:

| | | | | | |
|---|---|---|---|---|---|
| 4 | 5 | 6 | 8 | 9 | 10 |
| 1-3 | 1-4 | 1-5 | 2-6 | 3-6 | 4-6 |
| 2-2 | 2-3 | 2-4 | 3-5 | 4-5 | 5-5 |
| | | 3-3 | 4-4 | | |

at least one player position placing value at risk in the form of a physical chip or electronic data entry on a side bet wager;
the side bet wager based on at least three different ones of the fourteen possible dice roll outcomes occurring before a seven outcome is rolled, with payout odds on the side bet dependent upon at least one of the following side bet conditions providing payout odds in ascending order of odds:
at least three different ones of any of the fourteen possible dice roll outcomes paid at least 5:6;
at least three different ones of any of the fourteen possible dice roll outcomes except for 1-5, 2-6, 2-4, and 3-5 paid at least 6:5;
at least four different ones of any of the fourteen possible dice roll outcomes paid at least 3:1;
at least four different ones of any of the fourteen possible dice roll outcomes except for 1-5, 2-6, 2-4, and 3-5 paid at least 4:1;
at least five different ones of any of the fourteen possible dice roll outcomes paid at least 5:1;
at least five different ones of any of the fourteen possible dice roll outcomes except for 1-5, 2-6, 2-4, and 3-5 paid at least 6:1;
at least six different ones of any of the fourteen possible dice roll outcomes paid at least 20:1; and
at least six different ones of any of the fourteen possible dice roll outcomes except for 1-5, 2-6, 2-4, and 3-5 paid at least 50:1, wherein
upon each dice roll occurrence of any one of the fourteen possible dice roll outcomes a no-value lammer is placed over each specific one of the fourteen possible dice roll outcomes; and
a house resolving the side bet y when at least one of the side bet conditions is met.

The indicia indicating the fourteen possible dice roll outcomes can independently function as hopping bet identifiers by the placement of a wagering chip on at least one of the indicia for one of the fourteen possible dice roll outcomes. The no-value lammer may be a translucent or transparent lammer through which any underlying indicia can be seen. There may be different color translucent or transparent no-value lammers are used for each of multiple players at the craps gaming table.

The method may be executed wherein the craps gaming table comprises a blank translucent cover gaming table surface with images transmitted from an underside of the blank translucent cover, the images including:

a) a craps table layout with the indicia illustrating the fourteen possible dice roll outcomes, and upon occurrence of any one of the specific fourteen possible dice roll outcomes, a specific indicia of that any one of the specific fourteen possible dice roll outcomes is illuminated from the underside of the blank translucent cover.

The method, on any of the available systems may be executed with at least a portion of the side bet is contributed to a progressive jackpot total, and the side bet conditions include a 100% progressive jackpot payout for an occurrence of at least 6, 7 or 8 of the fourteen possible dice roll outcomes before any seven is rolled by a single shooter.

A craps gaming table with indicia illustrating fourteen possible dice roll outcomes of exactly:

| | | | | | |
|---|---|---|---|---|---|
| 4 | 5 | 6 | 8 | 9 | 10 |
| 1-3 | 1-4 | 1-5 | 2-6 | 3-6 | 4-6 |
| 2-2 | 2-3 | 2-4 | 3-5 | 4-5 | 5-5 |
| | | 3-3 | 4-4 | | |

and at a croupier position, at least six no-value lammers available to be placed exclusively by a croupier over each specific one of the fourteen possible dice roll outcomes as they occur during a dice roll of a single shooter.

The craps table may have the no-value lammers as translucent or transparent lammers through which any underlying indicia can be seen, and wherein different color translucent or transparent no-value lammers are used for each of multiple players at the craps gaming table.

The craps table may be provided as a blank translucent cover gaming table surface with images transmitted from an underside of the blank translucent cover, the images including:

a craps table layout with the indicia illustrating the fourteen possible dice roll outcomes, and upon occurrence of any one of the specific fourteen possible dice roll outcomes, a specific indicia of that any one of the specific fourteen possible dice roll outcomes is illuminated from the underside of the blank translucent cover.

Other variations may be practiced with this technology, such as minimum bets for complete bets may be required of 1 dollar to 100 dollars. But each player may have to bet more than 5 dollars to gets qualify for 100% and 10% of progressive payouts. Each craps table may have one monitor that shows each payout for every level, each spot who has progressive action, total amount of money of progressive, shows all the combination needs to roll. And one controller is able to punch in that which spot has active progressive bet, so certain percent of money will go to jackpot, and punch in each out-come of roll and will erase the combination from the monitor, To be able to provide higher odds against hitting all the combinations necessary for a jackpot (100%) winning outcome and to sure that the probabilities are high enough, the progressive system may make one daily or random hourly, or random round of play MAGIC NUMBER for each casino (4,5,6,8,9 or 10). Instead of hitting all the combination to get 100% of jackpot, shooter has to complete MAGIC NUMBER as last number. (example, if magic number is 4, shooter has to complete 4 at the end. If shooter complete 6 as last number, they will only get 10% of jackpot. Additionally, almost every level of payout will also change.)

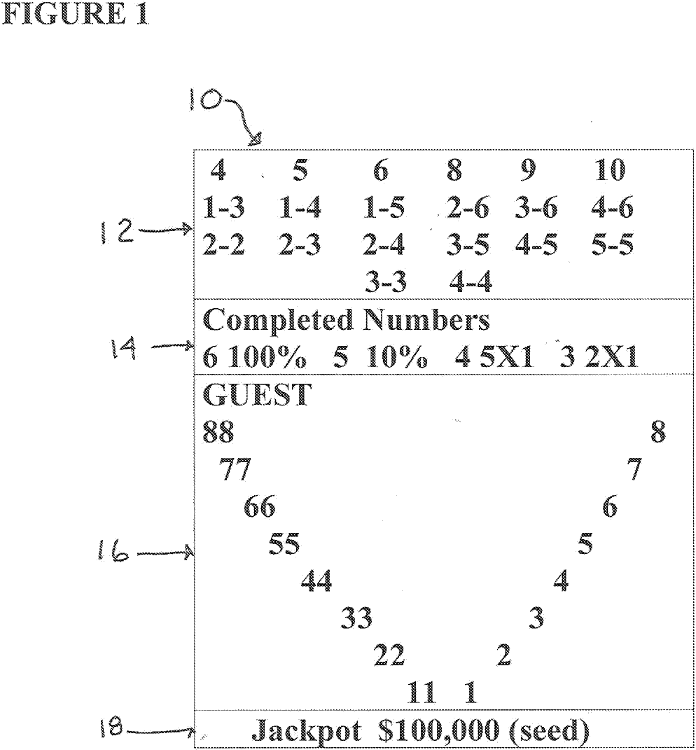

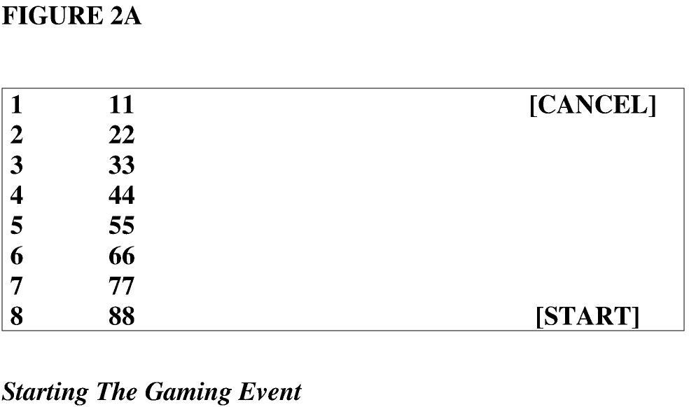

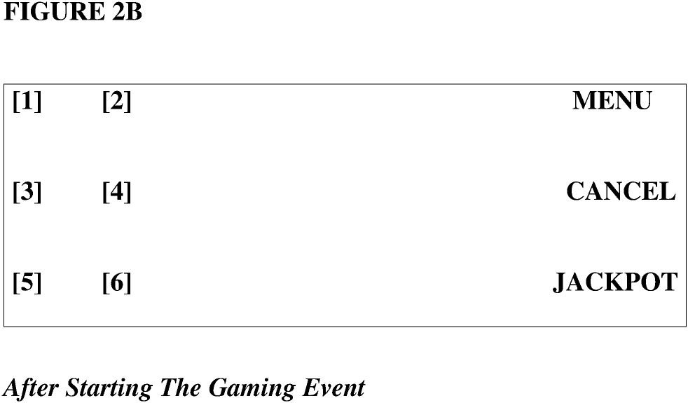

FIG. 1 shows a table layout 10 with Hopping Bets or Complete Craps Indicators, with area 12 being relatively standard on craps tables, as separate areas are provided for specific wagers on 1-1, 1-2, 5-6 and 6-6. Optional payouts on the jackpot, which may also be progressive as known in the art and payouts on different events (these are estimates and not fixed ion the execution of the gaming event) and are shown in 14. In area 16, the GUEST feature is shown where a specific player position is identified (8 left or 8 right for example) around the table. At the same time, the number of achieved specific die combination outcome rolls is identified. The amount of the jackpot (progressive or not) is displayed. FIG. 2A is a screen shot or display panel at a gaming table showing a different orientation of information on the display screen, but still providing the information as in FIG. 1.

FIG. 2B is a screen shot or display panel at a gaming table a different orientation of information on the display screen, but still providing the information as in FIG. 1.

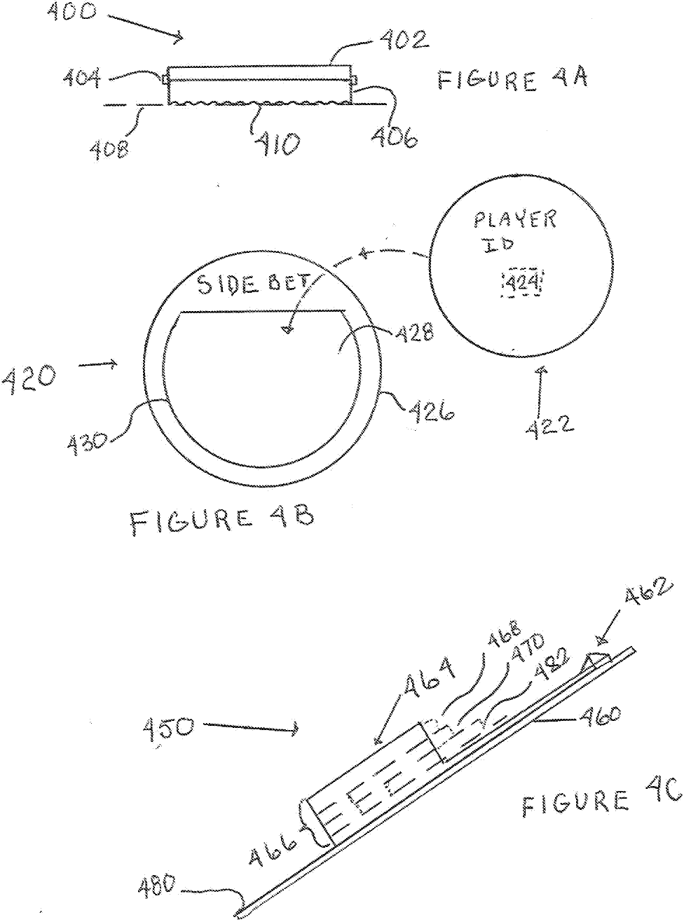

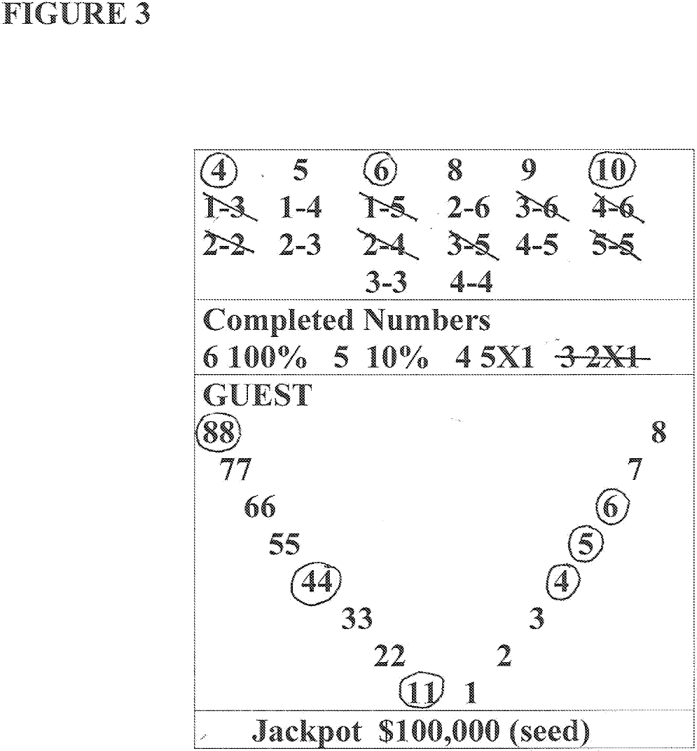

FIG. 3 shows the progression of outcomes that have occurred on previous rolls, with either numbers made by the dice struck-out or added, or cleared.

FIG. 4A shows a side view 400 of a side bet holder 406 attached to a table surface 408. The side bet holder 406 supports and may secure the valueless lammer 402 to indicate the side bet wager, and the lammer 402 may be further secured to the side bet holder 406 with guides or raised elements 404 to prevent undesired slipping of the lammer 402 when placed for the side bet wager. The bottom face of the side bet holder 406 is shown with a textured surface which may be indicative of a slip prevention surface, non-transferable adhesive (e.g., 3M brand Post-It® adhesive), hook-and-loop fastener systems, and the like.

FIG. 4B shows a top view 420 of a lammer 422 for the side bet which contains a Player ID (here RFID chip 424) slid into a side bet restrainer or holder 426. The side bet holder 426 is shown with ridges 430 surrounding an area 428 into which the lammer 422 can slide and be reasonable secure against slippage.

FIG. 4C shows a side view 450 of a multiple lammer restrainer or multi-player lammer restrainer 464 that may be applied to a craps table top or other game surface where side bets may be added or removed 460, allowing multiple players to make an identical side bet wager with each different player lammer 468, 470, 482 being viewable even though nestles against the inside back face 466 of the multiple lammer restrainer 464. Each slot may be indicative of a specific player wagering. For example, there may be eight (8) slots in the device, or two sets of slots with up to 4 openings on each holding device. The slots may be numbered on the sides as 1, 2, 3, 4 (on one holder, or some other indication of the specific wager position), 5, 6, 7, and 8 (one a larger holder). The holders may also have an information transmission capability (wired, as with the holder snapping into a communication circuit on the table, or wireless, with the powered (battery or wired) holder transmitting a signal that indicates the specific position of players from where a side bet wager has been placed). This signal can be displayed on a panel/display/screen as later indicated. This structure adds a high degree of security to all side bet wagers as the table crew inserts the standard side bet wager into a specific slot, calls out that number for the players to hear, the holder confirms the receipt of the wager and transmits the position to a central processor that displays the position information, and all of this is being done with an eye-in-the-sky video recording (standard at gaming tables in casinos) is recording all movement and activities. This greatly reduces the possibility of anyone altering original side bets as to player or game event.

The addition of the combination of the lammer and the side bet holder/restrainers is not trivial. Table space in casinos is highly competitive and expensive. To place a new bet on the casino floor, it has been necessary to print out new tops, install the newly printed tops, and familiarize the pit crew and players as to how side bets are to be placed and handled. As shown in FIGS. 4A and 4C, the side bet handler/restrainer can be added directly to existing table tops in a game play safe location, as for example near a wall where the pit crew/croupiers stand during the game. Side bet lammers (typically of a fixed and minimum amount, for example $1.00, $5.00, or $25.00) with the player identifying technology in the lammer (e.g., RFID, scannable bar code. QR code, player position identifier (there are typically eight - ten (8-10) player positions around the table, so the lammers may be numbered, player positions provided with unique colors (preferably inside the pit) which are matched with the side bet lammers, and each player position is provided with at least one player-unique lammer for use only with side bets. The lammers may be used in combination with a standard chip, with the chip nestling within the lammer to identify an amount of the wager. By doing this, a security feature is added wherein amounts of a side bet cannot be varied easily as the lammer/holder with chip stabilized therein cannot be illegally altered by the player. The lammer/holder may be relatively thin and translucent/transparent to display the chip amount, and may have the player identifier on the side or on the translucent/transparent face of the lammer/holder.

The multi-player lammer restrainer 450 may be temporarily attached to a table top and information about the specific side bet wagers placed could be printed on each multi-player lammer restrainer 450 and separate multi-player lammer restrainers 450 would be provided for each distinct wager.

This increases security, reduces expense, simplifies additions of side bet events or games to gaming tables and is itself a unique attribute of the present invention.

Alternative and additional content may be added to the gaming event such as each craps table has at least one monitor that shows: a) each payout for every level; b) each spot a player has wagered the progressive action; c) total amount of money of the progressive, and d) shows all the combination needed to roll to keep the jackpot event (fixed maximum payout) or the progressive going forward.

Each craps table may have one controller or be connected among multiple tables to a central controller (processor/server):
a) stick person is able to type in each person’s spot with active progressive bet, so certain percent of money will go to jackpot,
b) type in each out-come of roll and will erase the combination from the monitor.

1. A method of executing a side bet on a craps gaming table comprising:
providing a craps gaming table with indicia illustrating fourteen possible dice roll outcomes of exactly:

| | | | | | |
|---|---|---|---|---|---|
| 4 | 5 | 6 | 8 | 9 | 10 |
| 1-3 | 1-4 | 1-5 | 2-6 | 3-6 | 4-6 |
| 2-2 | 2-3 | 2-4 | 3-5 | 4-5 | 5-5 |
| | | 3-3 | 4-4 | | |

at least one player position placing value at risk in the form of a physical chip or electronic data entry on a side bet wager;
the side bet wager based on at least three different ones of the fourteen possible dice roll outcomes occurring before a seven outcome is rolled, with payout odds on the side bet dependent upon at least one of the following side bet conditions providing payout odds in ascending order of odds:
at least three different ones of any of the fourteen possible dice roll outcomes paid at least 5:6;
at least three different ones of any of the fourteen possible dice roll outcomes except for 1-5, 2-6, 2-4, and 3-5 paid at least 6:5;
at least four different ones of any of the fourteen possible dice roll outcomes paid at least 3:1;
at least four different ones of any of the fourteen possible dice roll outcomes except for 1-5, 2-6, 2-4, and 3-5 paid at least 4:1;
at least five different ones of any of the fourteen possible dice roll outcomes paid at least 5:1;
at least five different ones of any of the fourteen possible dice roll outcomes except for 1-5, 2-6, 2-4, and 3-5 paid at least 6:1;
at least six different ones of any of the fourteen possible dice roll outcomes paid at least 20:1; and
at least six different ones of any of the fourteen possible dice roll outcomes
except for 1-5, 2-6, 2-4, and 3-5 paid at least 50:1,
wherein upon each dice roll occurrence of any one of the fourteen possible dice roll outcomes a no-value lammer is placed over each specific one of the fourteen possible dice roll outcomes; and
a house resolving the side bet when at least one of the side bet conditions is met.

2. The method of claim 1 wherein the indicia indicating the fourteen possible dice roll outcomes can independently function as hopping bet identifiers by the placement of a wagering chip on at least one of the indicia for one of the fourteen possible dice roll outcomes.

3. The method of claim 2 wherein the no-value lammer is a translucent or transparent lammer through which any underlying indicia can be seen.

4. The method of claim 3 wherein different color translucent or transparent no-value lammers are used for each of multiple players at the craps gaming table.

5. The method of claim 1 wherein the craps gaming table comprises a blank translucent cover gaming table surface with images transmitted from an underside of the blank translucent cover, the images including:
a) a craps table layout with the indicia illustrating the fourteen possible dice roll outcomes, and upon occurrence of any one of the specific fourteen possible dice roll outcomes, a specific indicia of that any one of the specific fourteen possible dice roll outcomes is illuminated from the underside of the blank translucent cover.

6. The method of claim 1 wherein at least a portion of the side bet is contributed to a progressive jackpot total, and the side bet conditions include a 100% progressive jackpot payout for an occurrence of at least 6 of the fourteen possible dice roll outcomes before any seven is rolled by a single shooter.

7. The method of claim 1 wherein at least a portion of the side bet is contributed to a progressive jackpot total, and the side bet conditions include a 100% progressive jackpot payout for an occurrence of at least 7 of the fourteen possible dice roll outcomes before any seven is rolled by a single shooter.

8. The method of claim 1 wherein at least a portion of the side bet is contributed to a progressive jackpot total, and the side bet conditions include a 100% progressive jackpot payout for an occurrence of at least 8 of the fourteen possible dice roll outcomes before any seven is rolled by a single shooter.

9. The method of claim 5 wherein at least a portion of the side bet is contributed to a progressive jackpot total, and the side bet conditions include a 100% progressive jackpot payout for an occurrence of at least 6 of the fourteen possible dice roll outcomes before any seven is rolled by a single shooter.

10. The method of claim 1 wherein at least a portion of the side bet is contributed to a progressive jackpot total, and the side bet conditions include a 100% progressive jackpot payout for an occurrence of at least 7 of the fourteen possible dice roll outcomes before any seven is rolled by a single shooter.

11. The method of claim 1 wherein the lammer is placed into a lammer restrainer temporarily attached to a surface of the craps gaming table, the lammer restrainer dedicated to a single specific die outcome side bet.

12. The method of claim 11 wherein the lammer restrainer has multiple positions for supporting and displaying multiple player specific no-value lammers for the side bets.

13. The method of claim 12 wherein the multiple positions support the no-value lammers so that a portion of a surface of each non-value lammer can be seen by workers at the craps gaming table.

14. A craps gaming table with indicia illustrating fourteen possible dice roll outcomes of exactly:

| | | | | | |
|---|---|---|---|---|---|
| 4 | 5 | 6 | 8 | 9 | 10 |
| 1-3 | 1-4 | 1-5 | 2-6 | 3-6 | 4-6 |
| 2-2 | 2-3 | 2-4 | 3-5 | 4-5 | 5-5 |
| | | 3-3 | 4-4 | | |

and at a croupier position, at least six no-value lammers available to be placed exclusively by a croupier over each specific one of the fourteen possible dice roll outcomes as they occur during a dice roll of a single shooter.

15. The craps table of claim 14 wherein the no-value lammers are translucent or transparent lammers through which any underlying indicia can be seen.

16. The method of claim 12 wherein different color translucent or transparent no-value lammers are used for each of multiple players at the craps gaming table.

17. The craps table of claim 14 wherein the craps gaming table comprises a blank translucent cover gaming table surface with images transmitted from an underside of the blank translucent cover, the images including:
a) a craps table layout with the indicia illustrating the fourteen possible dice roll outcomes, and upon occurrence of any one of the specific fourteen possible dice roll outcomes, a specific indicia of that any one of the specific fourteen possible dice roll outcomes is illuminated from the underside of the blank translucent cover.

18. The craps table of claim 17 wherein a lammer restrainer temporarily attached to a surface of the craps gaming table, the lammer restrainer dedicated to a single specific die outcome side bet.

19. The craps gaming table of claim 17 wherein the lammer restrainer has multiple positions for supporting and displaying multiple player specific no-value lammers for the side bets.

20. The craps gaming table of claim 19 wherein the multiple positions support the no-value lammers so that a portion of a surface of each non-value lammer can be seen by workers at the craps gaming table.
